(19) United States
(12) Patent Application Publication
(10) Pub. No.: US 2006/0147730 A1
(43) Pub. Date: Jul. 6, 2006

(54) Adhesion promoter for ferroelectric polymer films

(75) Inventors: Kathleen M. O'Connell, Cumberland, RI (US); Anthony Zampini, Westborough, MA (US); Kathleen B. Spear-Alfonso, Northboro, MA (US); James Michael Mori, Medford, MA (US); Charles R. Szmanda, Westborough, MA (US)

Correspondence Address: Peter F. Corless;Rohm and Haas Electronic Materials LLC, 455 Forest Street, Marlborough, MA, 01752, US

(73) Assignee: Rohm and Haas Electronic Materials LLC, Marlborough, MA (US)

(21) Appl. No.: 11/235,669

(22) Filed: Sep. 26, 2005

Related U.S. Application Data
(60) Provisional application No. 60/613,136, filed on Sep. 24, 2004.

(51) Int. Cl. B32B 9/04

(52) U.S. Cl. 428/447

(57) ABSTRACT

A silane adhesion promoter composition is useful in producing a ferroelectric polymer film that is especially suitable for use in a data processing device. Also disclosed is a film stack and a data processing device comprising a ferroelectric film produced using the silane adhesion promoter

### BACKGROUND

The present invention relates to an adhesion promoter composition for use in forming ferroelectric polymer films and the films formed therewith, in particular, ferroelectric polymer films suitable for use in data processing devices.

Ferroelectrics are a class of dielectric materials that can be given a permanent electric polarization by application of an external electric field. Use of ferroelectric materials in data processing devices is disclosed in U.S. Patent Application No. US 2002/0044480 to Gudesen et al., which is directed to a ferroelectric data processing device comprising a thin film of ferroelectric material as a data-carrying medium. The film may be inorganic, a ceramic material, a polymer, or a liquid crystal. Use of ferroelectric polymers in data processing devices is also described, for example, by Y. Tajitsu et al., in “Investigation of Switching Characteristics of Vinylidene Fluoride/Trifluoroethylene Copolymers in Relation to Their Structures,” (Japanese Journal of Applied Physics, Volume 26, pp. 554-560, 1987).

It is known that only certain vinylidene fluoride polymers are ferroelectric, and that the presence of ferroelectricity and other properties is due at least in part to polymer characteristics such as polymer composition, structure, molecular weight, molecular weight distribution, the thermal history of the film, and the solvent used to form the film. See, e.g., the Abstract of an article by Cho, in Polymer, Volume 15, p. 67 (1991). Tashiro et al., in Macromolecules, Volume 35, p. 714 (2002), has performed a detailed structural analysis of the various vinylidene fluoride crystal morphologies. Vinylidene fluoride polymers occur in four distinct crystal morphologies, all monoclinic. Without intending to bound by theory, form I has essentially planar zigzag chains forming a polar structure in which CF₂ dipoles are parallel to each other along the crystallographic b-axis. The chains are tightly packed and tend to form large crystals. In form II, the CF₂ dipoles are packed in anti-parallel mode along the b-axis. Form II is therefore nonpolar and less tightly packed than form I. Form III is also a tightly packed polar unit cell, and is obtained by casting from highly polar (but not necessarily hydrogen bonding) solvents such as dimethylacetamide or dimethylformamide. Form III may also be obtained by annealing forms II or IV at high temperature. Finally, form IV is a polar structure in which the chains are packed in parallel mode. Form IV is also a desirable form from the standpoint of ferroelectric properties because it can interconvert with form II. Copolymers of vinylidene fluoride exhibit similar characteristics.

Ferroelectric polymer films may be formed by a variety of processes including by casting a composition comprising a ferroelectric polymer film precursor dissolved in a solvent onto a substrate, followed by removal of the solvent to produce the film. However, insufficient wetting of the substrate, compositional changes, and free energy gradients created by evaporation of the solvent can result in defects within the film, including orange peel and other defects that result from the formation of Bénard convection cells within the film as the solvent evaporates. See, for example, C. M. Hanson; P. E. Pierce; Cellular Convection in Polymer Coatings—An Assessment, 12 Ind. Eng. Chem. Prod. Res. Develop. 1973, p. 67.

In addition to Bénard convection cells, other variations in surface morphology can arise during the coating process, particularly in crystalline polymers. For example, during solvent evaporation, the surface of the film can have a surface free energy that is considerably higher than that of the original solution. The size of the critical nucleus for crystallite formation is usually correlated to the surface energy of the incipient film. Smaller numbers of relatively large, organized spherulitic crystal domains are generally obtained in regions of high surface energy and larger numbers of small, less organized crystal domains arise in regions of low surface energy. In applications where ferroelectric materials are used in electronic devices in which the electrodes are in contact with the ferroelectric material, the crystal domain and electrode sizes should be such that the electrical signals obtained from polling different devices are similar. For example, a large number of small crystal domains, relative to the electrode size, have a statistically better chance of yielding substantially similar electrical signals from a plurality of device structures during polling than a smaller number of large crystal domains. Control of free energy gradients during film formation and annealing therefore influences device performance.

In many applications using ferroelectric films, it is advantageous for the film to adhere well to the one or more surfaces with which it is in contact. For example, it is desirable to avoid delamination of the film from the substrate during subsequent processing steps. Such delamination can, for example, result from thermal cycling, immersion in fluids, or mechanical stresses. It is therefore particularly desirable that any additives to the film provide improved adhesion as well as control of the film morphology.

Other desired improvements include reduced polling fatigue, as manifested by the diminution of the remnant polarization after repeated polling of the ferroelectric device.

Attempts to control or eliminate defects, arising from non-uniformities in the ferroelectric film, delamination, or polling fatigue, include using co-solvents to change the film drying rate, using wetting agents to promote more even wetting of the substrate, or using surfactants to produce a more even surface tension throughout evaporation and cure of a film. Furthermore, in commonly assigned co-pending U.S. patent application Ser. Nos. 10/789,857 and 10/674,617, adhesion promoters are disclosed. While use of such adhesion promoters may improve some properties, they may also adversely affect properties that are important to use of the ferroelectric polymer film in a data processing device. For example, these processing aids may promote the formation of undesirable polymer crystal morphologies or have other adverse affects. Accordingly, there remains a need in the art for methods and compositions for the manufacture of ferroelectric polymer films, particularly films suitable for use in data processing devices, that are highly reproducible and that allow for control of film properties.

### STATEMENT OF THE INVENTION

In one aspect, a composite material comprises a substrate, a ferroelectric polymer film disposed on the substrate, and a silane adhesion promoter disposed between and in contact with the substrate and the film, wherein the silane is represented by the formula (I):
[(R¹O)₃₋ₘ(R²)ₘ]—Si—R³—(NH)—R⁴—(NH)—R³—Si-[(R²)ₘ(OR¹)₃₋ₘ] (I)
wherein each m is independently 0, 1, or 2; each R¹ is independently a hydrogen, methyl, ethyl, propyl or acyl group; each R² is independently a hydrogen, substituted or unsubstituted C₁-C₄ linear or branched chain alkyl or cycloalkyl moiety; each R³ is independently a substituted or unsubstituted C₁-C₁₂ linear or branched chain bivalent alkane, alkene, alkyne, cycloalkane, cycloalkene, arene, alkarene, aralkene, or heteroarene moiety; R⁴ is a substituted or unsubstituted C₁-C₁₂ linear or branched chain bivalent alkane, alkene, alkyne, cycloalkane, cycloalkene, arene, alkarene, aralkene, or heteroarene moiety; wherein a substituent on R², R³, or R⁴ may independently be a halogen, hydroxyl, amino, thiol, cyano, nitro, C₁-C₁₂ alkyl carboxy ester, acyl, C₁-C₁₂ alkoxy, carboxylate, or a mixture including one or more of the foregoing groups.

In another aspect, a composite material comprises a substrate, a ferroelectric polymer film disposed on the substrate, and a silane adhesion promoter disposed between and in contact with the substrate and the film, wherein the silane is represented by the formula (II):
[[(R⁵O)₃₋ₙ(R⁶)ₙ]—Si—R⁷]ₚ-(NH)-(R⁸)₂₋ₚ (II)
wherein each n is independently 0, 1, or 2; p is 1 or 2; each R⁵ is independently a hydrogen, methyl, ethyl, propyl or acyl group; each R⁶ is independently a hydrogen, substituted or unsubstituted C₁-C₆ linear or branched chain alkyl or cycloalkyl moiety; each R⁷ is independently a substituted or unsubstituted C₁-C₂₀ linear or branched chain bivalent alkane, alkene, alkyne, cycloalkane, cycloalkene, arene, alkarene, aralkene, or heteroarene moiety; R⁸ is a is a hydrogen, or substituted or unsubstituted C₁-C₂₀ linear or branched chain alkyl, alkenyl, alkynyl, cycloalkyl, cycloalkenyl, aryl, alkaryl, aralkyl, or heteroaryl moiety; wherein a substituent on R⁶, R⁷, or R⁸ may be a halogen, hydroxyl, cyano, amino, thiol, nitro, C₁-C₁₂ alkyl carboxy ester, acyl, C₁-C₁₂ alkoxy, carboxylate, or a mixture including one or more of the foregoing groups.

In still another aspect, a process for forming a composite material comprises disposing onto a substrate an adhesion promoter composition comprising the silane adhesion promoter represented by formula (I) and/or (II); disposing a ferroelectric polymer film precursor composition onto the adhesion promoter, wherein the ferroelectric polymer film precursor composition comprises a ferroelectric polymer and a casting solvent; and removing at least a portion of the casting solvent to produce the ferroelectric polymer film.

In still another aspect, there is provided a data processing device, wherein the ferroelectric polymer film is a continuous layer in contact with a substrate comprising a first electrode structure and a second electrode structure to form a logic element array including substantially mutually parallel strip electrodes such that the electrode structures mutually form a substantially orthogonal x, y matrix, and a portion of the ferroelectric polymer film at an intersection between an x electrode and a y electrode of the electrode matrix forms a logic element of the logic element array, electrically connected to form the data processing device.

### DETAILED DESCRIPTION

The adhesion promoter compositions disclosed herein can enhance adhesion of a ferroelectric polymer film to a substrate, suppress formation of defects, suppress the formation of undesirable polymer crystal morphologies, reduce the surface roughness, or a combination of one or more of the foregoing. Overall, the adhesion promoter aids in producing a uniform ferroelectric polymer film suitable for use in a data processing device. Manufacture of films using the adhesion promoter may also be also more reproducible, i.e., produce films having more consistent properties.

The adhesion promoters are generally silanes and silicones with hydrolyzable groups on one end of their molecules that may react with moisture to yield silanol groups, which in turn may react with or adsorb inorganic surfaces to enable strong bonds to be made. The other end or section of the molecules generally contain nonhydrolyzable groups capable of interacting with the ferroelectric polymer film.

It is possible for neighboring chains on the surface of the substrate to further condense to form a polysiloxane surface.

Also where the substrate is comprised of a composite material, for example conductive electrodes separated by an insulating dielectric material, a blend of adhesion promoters with different surface selective groups may be beneficial.

In one embodiment, the adhesion promoter composition comprises a silane having the following formula:
[(R¹O)₃₋ₘ(R²)ₘ]—Si—R³—(NH)—R⁴—(NH)—R³—Si-[(R²)ₘ(OR¹)₃-m]
wherein each m independently may be 0, 1, or 2. Each R¹ may be independently a hydrogen, methyl, ethyl, propyl or acyl group. Each R² may be independently a hydrogen, substituted or unsubstituted C₁-C₄ linear or branched chain alkyl or cycloalkyl moiety. Each of R³ and R⁴ may be independently a substituted or unsubstituted C₁-C₁₂ linear or branched chain bivalent alkane, alkene, alkyne, cycloalkane, cycloalkene, arene, alkarene, aralkene, or heteroarene moiety.

R³ and R⁴ are bivalent groups that may be derived from a variety of compounds. As used herein, when R³ and/or R⁴ is a “bivalent alkane group”, for example, the group is derived from removal of two hydrogens from the indicated compound, here an alkane. Each of R², R³, and/or R⁴ may be independently substituted by groups that do not interfere with manufacture or use of the composite. Suitable substituents include, for example, a halogen (i.e., fluorine, chlorine, bromine, iodine), hydroxyl (—OH), cyano (—CN), amino (—NH₂), thiol (—SH), nitro (—NO₂), C₁-C₁₂ alkoxy, C₁-C₁₂ alkylcarboxy ester (R—COO—R′), carboxylate (—COO⁻M⁺, wherein M is a hydrogen or other counter ion), or a mixture comprising one or more of the foregoing groups.

In one embodiment each of R¹, R², R³, and R⁴ is an unsubstituted linear alkyl group having one to four carbon atoms. In an exemplary embodiment, the adhesion promoter composition comprises bis[(trimethoxysilyl)propyl]-ethylenediamine.

In another embodiment, the adhesion promoter composition comprises a silane having the following formula:
[[(R⁵O)₃₋ₙ(R⁶)ₙ]—Si—R⁷]ₚ-(NH)—(R⁸)₂₋ₚ
wherein each n may be independently 0, 1, or 2 and p may be 1 or 2. Each R⁵ may be independently a hydrogen, methyl, ethyl, propyl or acyl group. Each R⁶ may be independently a hydrogen, substituted or unsubstituted C₁-C₄ linear or branched chain alkyl or cycloalkyl moiety. Each R⁷ may be independently a substituted or unsubstituted C₁-C₂₀ linear or branched chain bivalent alkane, alkene, alkyne, cycloalkane, cycloalkene, arene, alkarene, aralkene, or heteroarene moiety. R⁸ may be a hydrogen, or substituted or unsubstituted C₁-C₂₀ linear or branched chain alkyl, alkenyl, alkynyl, cycloalkyl, cycloalkenyl, aryl, alkaryl, aralkyl, or heteroaryl moiety. Each of R⁶, R⁷, and/or R⁸ may be independently substituted by groups that do not interfere with manufacture or use of the composite. Suitable substituents include, for example, a halogen, hydroxyl, cyano, amino, thiol, nitro, C₁-C₁₂ alkoxy, C₁-C₁₂ alkylcarboxy ester, carboxylate, or a mixture comprising one or more of the foregoing groups.

In one embodiment, each R⁵, R⁶, R⁷, and R⁸ is an unsubstituted linear alkyl group having one to four carbon atoms. Also desirable is R⁸ being a hydrogen. In an exemplary embodiment, the adhesion promoter composition comprises γ-aminopropyl triethoxysilane.

Specific adhesion promoters, according to formula I or II, that can be used are bis[(trimethoxysilyl)propyl]-ethylenediamine, γ-aminopropyl triethoxysilane, bis(trimethoxysilylpropyl)amine, (3-trimethoxysilylpropyl)diethylene-triamine, (aminoethylaminomethyl)phenethyl-trimethoxysilane, n-(2-aminoethyl)-3-aminopropylmethyl-dimethoxysilane, n-(2-aminoethyl)-3-aminopropyltrimethoxysilane, n-(6-aminohexyl)aminopropyl-trimethoxysilane, n-(2-aminoethyl)-11-aminoundecyl-trimethoxysilane, n-3-[amino(polypropylenoxy)]aminopropyl-trimethoxysilane, 3-aminopropylmethyldiethoxysilane, 3-aminopropyltrimethoxysilane, bis(2-hydroxyethyl)-3-aminopropyl-triethoxysilane, bis(n-methylbenzamido)ethoxymethylsilane, bis(methyldiethoxysilylpropyl)amine, ureidopropyltriethoxysilane, ureidopropyltrimethoxysilane, n-(3-triethoxysilylpropyl)-4,5-dihydroimidazole, triethoxysilylpropylethylcarbamate, n-(triethoxysilylpropyl)-o-polyethylene oxide urethane, n-methylaminopropyltrimethoxysilane, n-methylaminopropylmethyldimethoxysilane, (n,n-dimethylaminopropyl)trimethoxysilane, diethylaminomethyltriethoxysilane, or n-butylaminopropyltrimethoxysilane, or a combination comprising at least one of the foregoing adhesion promoters.

Combinations of adhesion promoters may be used, including combinations comprising a silane represented by formula I and/or a silane represented by formula II.

A ferroelectric polymer film precursor composition includes an organic ferroelectric polymer or prepolymer. Organic polymers that display ferroelectric properties and that are suitable for the formation of ferroelectric polymer films include, for example, certain polyamides (e.g., odd-numbered nylons), and ethylenically unsaturated, halogen-containing polymers formed from one or more polymerizable monomers such as, for example, vinylidene fluoride, tetrafluoroethylene, trifluoroethylene, chlorotrifluoroethylene, hexafluoropropene, vinylidene chloride, vinyl fluoride, and vinyl chloride. Oligomers and pre-polymers such as poly(vinylidene fluoride) and ethylene-tetrafluoroethylene alternating copolymer may also be used. These polymerizable monomers can be used either singly or as a combination of two or more co-monomers, such as terpolymers, tetrapolymers, and the like.

Non-halogenated co-monomers may also be present in the unsaturated, halogen-containing polymers to adjust the properties of the final film. Suitable non-halogenated co-monomers include, for example, acrylonitrile, acrylamide, methyl methacrylate, ethyl methacrylate, butyl methacrylate, octyl methacrylate, methacrylic acid, methyl acrylate, ethyl acrylate, butyl acrylate, octyl acrylate, 2-hydroxyethyl acrylate, glycidyl acrylate, acrylic acid, maleic anhydride, vinyl acetate, styrene, alpha-methyl styrene, trimethoxyvinylsilane, triethoxyvinylsilane, norbornene, butadiene, and mixtures comprising one or more of the foregoing co-monomers.

The non-halogenated co-monomers, when present, may be employed in amounts of less than or equal to 50 mole percent (mol %) based on the total weight of the ferroelectric polymer, more specifically less than or equal to 30 mol %, and even more specifically less than or equal to 20 mol % of the total polymer. When present, they may be in amounts of greater than or equal to 0.5 mol %, more specifically in amounts greater than or equal to 1 mol %, and still more specifically in amounts greater than or equal to 2 mol % of the total polymer.

In one embodiment, the ferroelectric polymer or prepolymer includes vinylidene fluoride, optionally copolymerized with trifluoroethylene, hexafluoropropylene, or both. Vinylidene fluoride is present in a concentration of 10 to 100 mol %. In one embodiment, a vinylidene fluoride concentration of greater than or equal to 50 mol % is employed. It is also possible to use greater than or equal to 70 mol % vinylidene fluoride. In another embodiment, a vinylidene fluoride concentration of less than or equal to 90 mol % is employed. It is also possible to use less than or equal to 85 mol %.

Trifluoroethylene, when present, typically includes up to 90 mol % of the total weight of the ferroelectric polymer. In one embodiment, a trifluoroethylene concentration of greater than or equal to 10 mol % is employed. It is also possible to use a trifluoroethylene concentration of greater than or equal to 20 mol %. In one embodiment, a trifluoroethylene concentration of less than or equal to 50 mol % is employed. It is also possible to use a trifluoroethylene concentration of less than or equal to 30 mol %. Hexafluoropropylene, when present, desirably comprises up to 50 mol % of the total ferroelectric polymer. A hexafluoropropylene concentration of greater than or equal to 10 mol % can be employed. Alternatively, a hexafluoropropylene concentration of greater than or equal to 15 mol % can be employed.

Polymerization conditions for manufacture of these polymers or prepolymers are well known. For example, a small amount of an initiator, such as an organic peroxide, may be present. Once polymerization has occurred, the unreacted monomers may be removed, by heating, by placing the polymer under a vacuum, by washing with an appropriate solvent, or a combination comprising at least one of the foregoing purification steps. The ferroelectric polymers or prepolymers used to form the films generally have a molecular weight of 100 to 800 kiloDaltons (kDa). Specifically, the ferroelectric polymers or prepolymers used to form the films have a molecular weight of greater than or equal to 200 kDa, and more specifically greater than or equal to 300 kDa. In one embodiment, the molecular weight is less than or equal to 700 kDa. In another embodiment, the molecular weight is less than or equal to 650 kDa. Suitable ferroelectric polymers are commercially available, for example co-(vinylidene fluoride trifluoroethylene) is available from Solvay Corporation.

The ferroelectric polymer film precursor composition may optionally further comprise a surface active agent such as a leveling agent. For example a (meth)acrylic copolymer represented by formula (III): 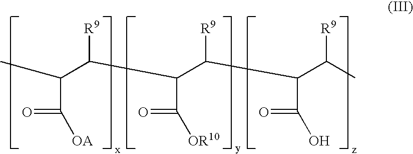
wherein each R⁹ is independently a hydrogen or methyl group. “(Meth)acrylic” as used herein refers to both acrylic and methacrylic groups. A in the above formula is —CR¹¹R¹²R¹³, wherein each R¹¹ is independently a hydrogen, substituted or unsubstituted C₁-C₂₀ linear or branched alkyl, alkenyl, alkynyl, cycloalkyl, cycloalkenyl, aryl, alkylaryl, aralkyl, or heteroaryl moiety, and each R¹² and R¹³ is independently a hydrogen, substituted or unsubstituted C₁-C₂₀ linear or branched chain alkyl, alkenyl, alkynyl, cycloalkyl, cycloalkenyl, aryl, alkaryl, aralkyl, or heteroaryl moiety, or R¹² and R¹³ together form a C₃-C₈ cycloalkyl group, with the proviso that when R¹² and R¹³ are each hydrogen, R⁹ is not a linear alkyl group. A is thus a branched chain carbon-containing group. Desirably, A has the formula —CH₂CR¹²R¹³, wherein R¹² and R¹³ are each independently a C₁-C₁₀ linear or branched alkyl, alkenyl, or alkaryl group, or a C₃-C₁₀ cycloalkyl or cycloalkenyl group. More desirably, R¹² and R¹³ are each independently a C₁-C₆ linear or branched alkyl or alkenyl group. R¹⁰ is a substituted or unsubstituted C₁-C₂₀ linear or branched alkyl, alkenyl, alkynyl, cycloalkyl, cycloalkenyl, aryl, alkylaryl, aralkyl, or heteroaryl moiety. Each of R¹⁰, R¹¹, R¹², and R¹³ may be independently substituted by groups that do not interfere with manufacture or use of the ferroelectric polymer film. Suitable substituents include, for example, a halogen, hydroxyl, cyano, nitro, C₁-C₁₂ alkoxy, C₁-C₁₂ alkylcarboxy ester, carboxylate, or a mixture comprising one or more of the foregoing groups. Subscripts x, y and z represent molar percents (mol %) such that the sum of x, y, and z totals 100 mol % (i.e., x+y+z=100 mol %). Subscripts x and y each independently vary from 10 to 70 mol %, with the proviso that x+y=60 mol % or more. Subscript z is less than or equal to 40 mol %. Alternatively, z may be less than or equal to 30%, or less than or equal to 20 mol %. When z is greater than zero, it may be as low as 0.01 mol %.

The ferroelectric polymer film precursor composition may optionally further comprise other surface active agents to improve coating properties. Combinations of the above-described (meth)acrylic surface active agents with additional surface active agents can exhibit synergistic properties such as at least one of adhesion improvements, improvements in film morphology or lower polling fatigue that may not be obtained to the same degree from formulations containing the individual surface active agents. Suitable additional surface active agents include, for example, polyoxyethylene lauryl ether, polyoxyethylene octyl phenyl ether, polyoxyethylene nonyl phenyl ether, polyoxyethylene glycol dilaurate, polyoxyethylene glycol distearate, as well as organofluoro surfactants including those available commercially under the trade names Megafax F171, F172, F173, F471, R-07, R-08, (Dainippon Ink & Chemicals, Incorporated), Fluorad FC171, FC430, FC431 (3M Corporation), ASAHI GUARD AG710, Surflon S-382, SC-101, SC-102, SC-103, SC-104, SC-105, SC-106 (Asahi Glass Co., Ltd.), KP341 (Shin-Etsu Chemical Co., Ltd.), Polyflow No. 75, No. 95 (Kyoeisha Chemical Co., Ltd.), Silwet L-7604 (Witco Chemical Corp.), and NBX-7, NBX-8, and NBX-15 (NEOS Company Limited).

The surface active agent may be present at 0.001 to 1.0 wt %, based on the total weight of the ferroelectric polymer present in the ferroelectric polymer film precursor composition. In one embodiment, the concentration of surface active agent is 0.005 to 0.75 wt %. In another embodiment, the concentration of surface active agent is 0.05 to 0.5 wt %.

Other adhesion promoters that may be used include for example, organotitanates, aluminates, zirconates, zircoaluminates, or organic acid-chromium variants of formula I and/or formula II. The specific variant is chosen based on the composition of the substrate surface onto which the adhesion promoter is disposed.

Composites comprising ferroelectric polymer films and the above-described adhesion promoters may be formed by wet processes using solvents and/or dispersions. Such processes include, for example, casting, blade coating, roll coating, spin coating, dipping, and spray coating, as well as printing methods such as lithography, relief printing, intaglio, perforated plate printing, screen-printing, and transfer printing. Still other wet processes include electrochemical methods such as electrodeposition, electropolymerization, micelle electrolysis (see, for example, JP-A-63-243298), and Langmuir-Blodgett methods using monomolecular films formed on water. The process by which the ferroelectric polymer films are formed can also include a combination comprising at least one of the foregoing processes. Spin coating methods are often used.

In casting and other wet processes, the particular compositions may be dissolved or dispersed in a casting solvent to form a casting composition. In one embodiment, the adhesion promoter composition and the ferroelectric polymer film precursor composition may be cast separately (i.e., as two casting compositions) onto a substrate. When an adhesion promoter composition casting solvent is used, it may or may not be the same as the ferroelectric polymer film precursor composition casting solvent. In another embodiment, the adhesion promoter composition and the ferroelectric polymer film precursor composition are cast simultaneously (i.e., as a single casting composition).

Suitable solvents may include a single solvent or a mixture of miscible solvents, and are those that dissolve (or suspend) and retain the components of the particular composition in solution (or suspension) through a range of concentrations. The solvents furthermore are such that they evaporate to form a smooth, desirably defect-free layer of the particular composition.

The amount of casting solvent for the adhesion promoter composition does not appear to be critical. One suitable amount is that effective to provide a solution (or dispersion) comprising 0.001 to 5 weight percent (wt %) of the adhesion promoter based on the total weight of the adhesion promoter casting composition. In one embodiment, the solution comprises less than or equal to 1 wt % of the adhesion promoter. In another embodiment, the solution comprises less than or equal to 0.1 wt % of the adhesion promoter. The amount of adhesion promoter in the casting composition and the amount deposited are effective to provide an adhesion promoter thickness (without solvent) of 1 to 100 nanometers (nm).

Casting solvents for the adhesion promoter composition may have an evaporation rate greater than 1.5 at 250° C. Suitable casting solvents for the adhesion promoter composition include for example, alcohols such as methanol, ethanol, n-propanol, isopropanol, butanol, and the like, or a combination comprising at least one of the foregoing solvents.

The amount of casting solvent for the ferroelectric polymer film precursor composition is effective to provide a solution (or dispersion) comprising at least 1.5 wt % of the precursor composition, more typically greater than 2 wt %, and still more typically greater than 2.2 wt %. Higher concentrations, for example up to about 5 wt. % may be used, provided that satisfactory films are obtained. Ferroelectric polymer film precursor composition casting solvents and solvent mixtures with boiling points greater than or equal to 100° C. are desirable. Ferroelectric polymer film precursor composition casting solvents with evaporation rates, at 25° C., less than or equal to that of n-butyl acetate are also desirable. Suitable ferroelectric polymer film precursor composition casting solvents include, for example, 2-heptanone, diethyl carbonate, isobutyl isobutyrate, ethyl benzene, 1-decanol, 1-isopropyl-2-methylimidazole, ethyl lactate, 2-hexyl acetate, diethylene glycol butyl ether acetate, diethylketone, 1-methoxy-2-butanol, propylene glycol methyl ether acetate, formamide, dipropylene glycol, gamma-butyrolactone, dimethyl sulfoxide, acetonitrile, n-butyl benzyl phthalate, diethylene glycol, dimethyl phthalate, acetophenone, methoxypropyl acetamide, N,N-dimethylacetamide, ethylene glycol, ethyl cinnamate, diethyl phthalate, N-methylmorpholine, benzonitrile, ethylene glycol 2-ethylhexyl ether, benzyl alcohol, morpholine, ethylene glycol diacetate, propylene glycol, 1,4-dioxane, furfuryl alcohol, cyclohexanone, propylene glycol butyl ether, ethylene glycol monoethyl ether, diethylene glycol ethyl ether, ethylene glycol ethyl ether, ethyl-3-ethoxypropionate, ethylene glycol methyl ether, propyleneglycol methyl ether, N-ethylmorpholine, methyl n-propyl ketone, mesitylene, diethylene glycol ethyl ether acetate, diethyleneglycol methyl ether, cyclohexanol, 4-methyl-3-penten-2-one, 2-methyl-2,4-pentanediol, ethyl benzene, 1-decanol, 1-isopropyl-2-methylimidazole, ethyl lactate, 2-hexyl acetate, diethylene glycol butyl ether acetate, diethylketone, 1-methoxy-2-butanol, diethylene glycol butyl ether, or a combination comprising at least one of the foregoing solvents.

Casting compositions may be filtered to remove particulates that may adversely affect film properties by depth filtration using, for example, materials such as diatomaceous earth or a filter cake comprising fibrous materials such as cellulose fibers. Alternatively, or in addition, casting compositions may be filtered by absolute filtration using, for example, commercially available absolute filters with compatible media such as polyethylene, polytetrafluoroethylene, nylon or the like, and with filter ratings from 0.01 to 1.0 micrometers absolute as required by the application.

In one embodiment, the ferroelectric polymer film may be formed by disposing the adhesion promoter composition onto a substrate, optionally removing some or all of the casting solvent for the adhesion promoter composition, disposing the ferroelectric polymer film precursor composition onto and in contact with the adhesion promoter, and removing at least a portion of any casting solvent. For example, in spin casting, the adhesion promoter composition comprising 0.05 to 0.10 wt % of the adhesion promoter is applied to a substrate rotating at 500 to 10,000 revolutions per minute (RPM) at a temperature of 15 to 30° C. The spin-coated adhesion promoter layer may or may not be heated (e.g., baked on a hotplate) to remove a portion of the adhesion promoter composition casting solvent. Subsequently, the ferroelectric polymer film precursor composition comprising 1 to 5 wt % of the film forming polymer and optional additives is applied to the rotating adhesion promoter covered substrate surface at a temperature of 15 to 30° C. The spin-coated ferroelectric polymer film is then heated in a similar fashion at 80 to 150° C. to remove a portion of the ferroelectric polymer film precursor composition casting solvent.

Films formed using the above described adhesion promoter compositions have improved properties that may be adjusted depending on the desired end use. The films have an average roughness, as measured as a mean-square deviation using atomic force microscopy (AFM), of 25 angstroms (Å) or less. In one embodiment, the films have an average roughness of less than or equal to 20 Å. Alternatively, the average roughness may be less than or equal to 15 Å. In one embodiment, the surface roughness is 1 Å to 25 Å. A film formed using the above described adhesion promoter compositions can have a decreased roughness compared to films produced without the adhesion promoter compositions, which is desirable for reproducibility, reliability, reduced polling fatigue, good electrode contact, and dense packing in data processing devices.

In addition, the ferroelectric polymer film has an average crystal domain size, as measured by an atomic force microscope (AFM) of 1 to 100 nm. In one embodiment, the average domain size is less than or equal to 90 nm. In another embodiment the average domain size is less than or equal to 80 nm. In still another embodiment, the average domain size is less than or equal to 70 nm. Again, a film formed using the above described adhesion promoter composition may have a decreased average domain size compared to a film produced without the adhesion promoter composition, which is desirable for reproducibility, reliability, reduced polling fatigue, good electrode contact, and dense packing in data processing devices.

A variety of other film properties may be adjusted by appropriate selection and use of the above described adhesion promoter composition including polydispersity, properties related to hysteresis (e.g., saturation potential, coercive field strength, and permittivity), reliability (e.g., fatigue, aging, time dependence dielectric breakdown, imprint, and relaxation), kinetic properties (e.g., ferroelectric switching time), and thermodynamic properties (e.g., Curie transition temperature of the film).

The ferroelectric polymer films can have a polydispersity of 1 to less than or equal to 3. Alternatively, the polydispersity is less than or equal to 1.5. In one embodiment, the polydispersity is less than or equal to 1.3.

Hysteresis is the observed lagging or retardation of the polarization effect when the electric field acting upon a ferroelectric polymer film is changed from a previously induced condition. The shape and magnitude of a hysteresis loop are characteristic of a particular ferroelectric material. The hysteresis can be shown graphically in a plot of the observed polarization (P) verses the magnitude of the applied electric field (E). The shape and magnitude of a hysteresis loop are characteristic of a particular ferroelectric material. For example, as the electric field is increased, the crystalline domains of the film become oriented with the field. When no further reorientation can occur, the curve becomes flat. The polarization value at the intersection of a line extrapolated to the polarization axis at E=0 is the saturation polarization (designated Psat). The magnitude of the polarization at E=0 on the hysteresis loop is the remnant polarization (designated Pr).

The difference between the remnant polarization and the saturation polarization of the ferroelectric polymer film may be measured according to Fedosov, (see Electrical Properties of Ferroelectric Polymers During the Switching of Polarization, Sergiy Fedosov; http://www.tu-darmstadt.de/fb/ms/fg/em/Ferroelektrika.pdf). In one embodiment, the difference is 0.1 to 70 millicoulombs per square meter (mC/m²). Specifically, the difference may be less than or equal to 50 mC/m², and more specifically, less than or equal to 25 mC/m². The coercive field strength is defined as the horizontal intercept of the hysteresis loop (designated Ec). Desirably, the ferroelectric polymer film has a coercive field strength as measured according to Christie et al., J. Polymer Sci.: Part B, Vol. 35, p. 2671, (1997) of 20-80 mega Volts per meter (MV/m) consistent with a more square hysteresis loop, as compared to, for example, pure vinylidene fluoride polymers. In one embodiment, the coercivity field strength is less than or equal to 70 MV/m. In another embodiment, the coercivity field strength is less than or equal to 50 MV/m. Another property of ferroelectric polymer films is differential permittivity, which is the slope of the hysteresis loop measured at any point on the curve. The differential permittivity of the ferroelectric material at Ec is desirably, 0.5 to 15 nanocoulombs per meter per volt (nC/m*V). Specifically, the differential permittivity may be greater than or equal to 1, and more specifically greater than or equal to 2.5 nC/m*V.

As is known, transforming the polymer from a ferroelectric state into a paraelectric state can destroy the ferroelectric properties of a polymer film. These same properties can be made to reappear upon subsequent conversion of the polymer back into a ferroelectric state. Such changes in thermodynamic states can be brought about by changes in temperature. The Curie transition temperature, often abbreviated as Tc, is the temperature at which this change occurs. The Curie transition temperature of the ferroelectric polymer film is desirably greater than 90° C. In one embodiment, the Curie transition temperature is greater than or equal to 110° C. In another embodiment, the Curie transition temperature is 90 to 145° C.

The ferroelectric polymer film may be used in the form in which it was originally prepared, or it may undergo additional processing steps, for example crosslinking, irradiation with an electron beam having an energy greater than 5 kiloelectron volts (keV) and a dose greater than 0.5 micro Curies per square centimeter (μC/cm²), or irradiation with X-ray radiation having a wavelength of less than 20 nm and a dose greater than 1 millijoule square centimeter (mJ cm²). The film may also be stretched along one or more axes; heat treated (e.g., annealed) at a temperature of from 100° C. to 130° C., for 1 minute to 12 hours; coated with a conducting or semiconducting passivation layer (e.g., colloidal graphite), a conducting polymer (e.g., partially ionized polythiophene, PEDOT-PSS, or partially ionized polyaniline), evaporated small molecules (e.g., 2-amino-1H-imidazole-4,5-dicarbonitrile), evaporated donor-accepter complexes (e.g., tetrathiafulvalene-tetracyanoquinodimethane), or may have an inorganic layer such as indium-tin oxide (ITO). The additional conditioning steps may also include any combination comprising at least one of the foregoing treatments.

The thickness of the ferroelectric polymer film is dependent on the final application. For example, when the ferroelectric polymer film is to be used in a data processing device, the film can have a thickness of 15 to 300 nm. Within this range, a thickness of greater than or equal to 20 nm is desirable. Specifically the thickness may be less than or equal to 100 nm, and more specifically less than or equal to 80 nm.

In another embodiment, the adhesion promoter composition can be used to form an additional layer in a film stack. The ferroelectric polymer film or film stack may used in a data processing device, including, for example, a logic element configured memory cells as described in U.S. Patent Application No. US 2002/0044480 to Gudesen et al. For example, a data storage device may comprise a ferroelectric polymer film located as a continuous layer or sheet between a first and a second electrode structure of strip electrodes. The first and the second electrode structure are dimensioned, located and positioned to form a two-dimensional x, y-matrix with, for example, the x electrodes being columns in the matrix, and the y electrodes being rows in the matrix. The portion of the ferroelectric polymer film at an intersection between an x electrode and a y electrode of the electrode matrix forms a logic element electrically connected to respective driver and control circuits for driving the electrodes and detection of output signals, thus forming the data processing device. The data processing device may also include a plurality of logic element arrays stacked one on top of another and electrically isolated from one another by a layer of an electrically isolating material provided between each of the logic element arrays. In turn, each of the logic elements of each of the logic element arrays is electrically connected to form the data processing device.

Suitable electrode materials include, for example alkaline earth metals, transition metals, transition metal oxides, main group metals, Group IV semiconductors, Group III-V semiconductors, Group II-VI semiconductors, semiconductors comprising main group oxides such as indium tin oxide (ITO), and the like, as well as combinations, for example alloys, comprising at least one of the foregoing materials. Organic semiconductors may also be used, for example polyaniline, polythiophene, polymerized or oligomerized thiophene derivatives such as poly (2,3-dihydro-thieno[3,4-b][1,4]dioxine), poly arylene vinylenes such as polyphenylene vinylene, and the like, as well as combinations, for example alloys comprising at least one of the foregoing organic semiconductors. The degree of partial oxidation or partial reduction of the semiconducting polymer can be selected to optimize device performance. Electrode materials disposed about the ferroelectric polymer can be the same or different and can be selected to give optimum electronic performance. Moreover, electrodes can include a plurality of conducting and/or semiconducting layers.

Dielectric materials, for example, silicon dioxide, silicon nitride, silicon oxynitride, titanium nitride, aluminum oxide, or nonconducting polymers can be interposed between the electrode and the ferroelectric film, as long as the dielectric is sufficiently thin to allow a sufficiently high field strength in the ferroelectric film.

The use of the silane adhesion promoters disclosed herein provides several advantages including one or a combination of enhanced adhesion to the substrate, suppression of formation of Benard convection cells, and suppression of formation of undesirable crystal morphologies during drying.

The invention is further illustrated by the following non-limiting examples. The polymer used in the examples was a 75%/25% mol/mol copolymer of vinylidene fluoride and trifluoroethylene with Mn=420,000 and Mw=630,000 Daltons.

### EXAMPLE 1 (COMPARATIVE)

A 2.5 wt % solution of a 75%/25% mol/mol copolymer of vinylidene fluoride and trifluoroethylene in diethyl carbonate was prepared and filtered using a 0.2 μm (micrometer) nylon filter.

The filtered solution was then spin coated on a silicon wafer substrate at 2500 RPM for 30 seconds (sec), baked on a proximity hotplate at 120° C. for 90 sec and chilled on a 20° C. cold plate for 30 sec to give a cast film thickness of approximately 80 nm.

In a manner similar to that described in ASTM D3359-02, an X-cut of approximately 1 inch (2.54 cm) long by ¾ inch (1.90 cm) wide was made in the cast film down to the substrate using a sharp razor blade. A 3 inch (7.62 cm) strip of ¾ inch (1.90 cm) wide semitransparent pressure sensitive tape (Scotch Magic Tape made by the 3M Corporation, or similar) was then applied to the X-cut and pulled sharply away from the coating surface. A large area of the cast film beyond the area of the applied tape was removed from the substrate indicating that, without an adhesion promoter, adhesion of the film to the substrate was not optimal.

### EXAMPLE 2

A 0.05 wt % solution of bis[(trimethoxysilyl)propyl]-ethylenediamine in isopropyl alcohol was prepared and subsequently spin coated on a silicon wafer substrate at 3000 RPM for 30 sec, to give a cast film thickness of approximately 3 nm.

A 2.5 wt % solution of a 75%/25% mol/mol copolymer of vinylidene fluoride and trifluoroethylene in diethyl carbonate was prepared and filtered using a 0.2 (micrometer) μm nylon filter. The filtered solution was then spin coated on the adhesion promoter layer at 2500 RPM for 30 sec, baked on a proximity hotplate at 120° C. for 90 sec and chilled on a 20° C. cold plate for 30 sec to give a cast film thickness of approximately 80 nm.

An X-cut of approximately 1 inch (2.54 cm) long by ¾ inch (1.90 cm) wide was made in the cast film down to the substrate using a sharp razor blade. A 3 inch (7.62 cm) strip of ¾ inch (1.90 cm) wide semitransparent pressure sensitive tape (Scotch Magic Tape made by the 3M Corporation or similar) was then applied to the X-cut and pulled sharply away from the coating surface. Substantially none of the film under, and none of the film beyond, the applied tape was removed.

### EXAMPLE 3

A film was prepared according to Example 2, except that the concentration of the adhesion promoter casting solution was increased to 0.1% wt % bis[(trimethoxysilyl)propyl]-ethylenediamine in isopropyl alcohol.

When the tape was sharply pulled from the X-cut, substantially none of the film under the applied tape was removed. In addition, none of the film beyond the applied tape was removed.

### EXAMPLE 4

A film was prepared according to Example 2, except that the adhesion promoter was γ-aminopropyl triethoxysilane.

When the tape was sharply pulled from the X-cut, there was some slight removal of the film immediately adjacent to the X-cut, and there was no removal of the film beyond the boundaries of the applied tape.

### EXAMPLE 5

A film was prepared according to Example 4, except that the concentration of the adhesion promoter was increased to 0.10 wt % γ-aminopropyl triethoxysilane in isopropyl alcohol.

When the tape was sharply pulled from the X-cut, there was some slight removal of the film immediately adjacent to the X-cut, and there was no removal of the film beyond the boundaries of the applied tape.

### EXAMPLE 6 (COMPARATIVE)

A film was prepared according to Example 2, except that the adhesion promoter was tris (3-trimethoxy silylpropyl)iso cyanurate.

When the tape was sharply pulled from the X-cut, a large area of the cast film beyond the area of the applied tape was removed from the substrate.

### EXAMPLE 7 (COMPARATIVE)

A film was prepared according to Example 2, except that the adhesion promoter was (3,3,3-trifluoropropyl)trimethoxysilane.

When the tape was sharply pulled from the X-cut, a large area of the cast film beyond the area of the applied tape was removed from the substrate.

### EXAMPLE 8 (COMPARATIVE)

A film was prepared according to Example 2, except that the adhesion promoter was 2-cyanoethyl trimethoxysilane.

When the tape was sharply pulled from the X-cut, a large area of the cast film beyond the area of the applied tape was removed from the substrate.

### EXAMPLE 9

A 2.5 wt % solution of a 75%/25% mol/mol copolymer of vinylidene fluoride and trifluoroethylene in diethyl carbonate was prepared and less than 1 wt % solid γ-aminopropyl triethoxysilane was added to the solution. The solution was filtered using a 0.2 μm nylon filter.

The filtered solution was then spin coated on silicon wafer substrate at 2500 RPM for 30 sec, baked on a proximity hotplate at 120° C. for 90 sec and chilled on a 20° C. cold plate for 30 sec to give a cast film thickness of approximately 80 nm.

There was essentially no change in the morphology (as observed by AFM) relative to the films produced according to Examples 4 and 5.

When the tape was sharply pulled from the X-cut, some removal of the film immediately adjacent to the X-cut was observed but there was no removal of the film beyond the boundaries of the applied tape.

As used herein, the terms “the”, “a”, and “an” do not denote a limitation of quantity, but rather denote the presence of at least one of the referenced item. Furthermore, all ranges disclosed herein are inclusive of the endpoints and independently combinable.

What is claimed is:

1. A composite, comprising
a substrate;
a ferroelectric polymer film disposed on the substrate; and
a silane adhesion promoter disposed between the substrate and the film, wherein the adhesion promoter is represented by the formula:
[(R¹O)₃₋ₘ(R²)ₘ]—Si—R³—(NH)—R⁴—(NH)—R³—Si-[(R²)ₘ(OR¹)₃₋ₘ]
wherein each m is independently 0, 1, or 2; each R¹ is independently a hydrogen, methyl, ethyl, propyl, or acyl group; each R² is independently a hydrogen, substituted or unsubstituted C₁-C₄ linear or branched chain alkyl or cycloalkyl moiety; each R³ is independently a substituted or unsubstituted C₁-C₁₂ linear or branched chain bivalent alkane, alkene, alkyne, cycloalkane, cycloalkene, arene, alkarene, aralkene, or heteroarene moiety; R⁴ is a substituted or unsubstituted C₁-C₁₂ linear or branched chain bivalent alkane, alkene, alkyne, cycloalkane, cycloalkene, arene, alkarene, aralkene, or heteroarene moiety; wherein a substituent on R², R³, or R⁴ may independently be a halogen, hydroxyl, amino, thiol, cyano, nitro, C₁-C₁₂ alkyl carboxy ester, acyl, C₁-C₁₂ alkoxy, carboxylate, or a mixture including one or more of the foregoing groups.

2. The composite of claim 1, wherein the silane adhesion promoter is bis[(trimethoxysilyl)propyl]-ethylenediamine.

3. A composite, comprising
a substrate;
a ferroelectric polymer film disposed on the substrate; and
a silane adhesion promoter disposed between the substrate and the film, wherein the adhesion promoter is represented by the formula:
[[(R⁵O)₃₋ₙ(R⁶)ₙ]—Si—R⁷]ₚ-(NH)—(R⁸)₂₋ₚ
wherein each n is independently 0, 1, or 2; p is 1 or 2; each R⁵ is independently a hydrogen, methyl, ethyl, propyl, or acyl group; each R⁶ is independently a hydrogen, substituted or unsubstituted C₁-C₆ linear or branched chain alkyl or cycloalkyl moiety; each R⁷ is independently a substituted or unsubstituted C₁-C₂₀ linear or branched chain bivalent alkane, alkene, alkyne, cycloalkane, cycloalkene, arene, alkarene, aralkene, or heteroarene moiety; R⁸ is a is a hydrogen, or substituted or unsubstituted C₁-C₂₀ linear or branched chain alkyl, alkenyl, alkynyl, cycloalkyl, cycloalkenyl, aryl, alkaryl, aralkyl, or heteroaryl moiety; wherein a substituent on R⁶, R⁷, or R⁸ may be a halogen, hydroxyl, cyano, amino, thiol, nitro, C₁-C₁₂ alkyl carboxy ester, acyl, C₁-C₁₂ alkoxy, carboxylate, or a mixture including one or more of the foregoing groups.

4. The composite of claim 3, wherein the silane adhesion promoter is γ-aminopropyl triethoxysilane.

5. A data processing device comprising the composite of claim 1 or 3.

6. The data processing device of claim 5, wherein the film is disposed between a plurality of electrodes.

7. A film stack comprising the ferroelectric polymer film of claims 1 or 3 disposed on a substrate.

8. A data processing device comprising the film stack of claim 7.

9. A process for forming a composite, the process comprising:
disposing onto a substrate an adhesion promoter composition comprising a silane adhesion promoter represented by the formula:
[(R¹O)₃₋ₘ(R²)ₘ]—Si—R³—(NH)—R⁴—(NH)—R³—Si-[(R²)ₘ(OR¹)₃₋ₘ]
wherein each m is independently 0, 1, or 2; each R¹ is independently a hydrogen, methyl, ethyl, propyl, or acyl group; each R² is independently a hydrogen, substituted or unsubstituted C₁-C₄ linear or branched chain alkyl or cycloalkyl moiety; each R³ is independently a substituted or unsubstituted C₁-C₁₂ linear or branched chain bivalent alkane, alkene, alkyne, cycloalkane, cycloalkene, arene, alkarene, aralkene, or heteroarene moiety; R⁴ is a substituted or unsubstituted C₁-C₁₂ linear or branched chain bivalent alkane, alkene, alkyne, cycloalkane, cycloalkene, arene, alkarene, aralkene, or heteroarene moiety; wherein a substituent on R², R³, or R⁴ may independently be a halogen, hydroxyl, amino, thiol, cyano, nitro, C₁-C₁₂ alkyl carboxy ester, acyl, C₁-C₁₂ alkoxy, carboxylate, or a mixture including one or more of the foregoing groups;
disposing a ferroelectric polymer film precursor composition onto the adhesion promoter, wherein the ferroelectric polymer film precursor composition comprises a ferroelectric polymer and a casting solvent; and
removing at least a portion of the casting solvent composition to produce the ferroelectric polymer film.

10. A process for forming a composite, the process comprising:
disposing onto a substrate an adhesion promoter composition comprising a silane adhesion promoter represented by the formula:
[[(R⁵O)₃₋ₙ(R⁶)ₙ]—Si—R⁷]ₚ-(NH)—(R⁸)₂₋ₚ
wherein each n is independently 0, 1, or 2; p is 1 or 2; each R⁵ is independently a hydrogen, methyl, ethyl, propyl or acyl group; each R⁶ is independently a hydrogen, substituted or unsubstituted C₁-C₆ linear or branched chain alkyl or cycloalkyl moiety; each R⁷ is independently a substituted or unsubstituted C₁-C₂₀ linear or branched chain bivalent alkane, alkene, alkyne, cycloalkane, cycloalkene, arene, alkarene, aralkene, or heteroarene moiety; R⁸ is a is a hydrogen, or substituted or unsubstituted C₁-C₂₀ linear or branched chain alkyl, alkenyl, alkynyl, cycloalkyl, cycloalkenyl, aryl, alkaryl, aralkyl, or heteroaryl moiety; wherein a substituent on R⁶, R⁷, or R⁸ may be a halogen, hydroxyl, cyano, amino, thiol, nitro, C₁-C₁₂ alkyl carboxy ester, acyl, C₁-C₁₂ alkoxy, carboxylate, or a mixture including one or more of the foregoing groups;
disposing a ferroelectric polymer film precursor composition onto the adhesion promoter, wherein the ferroelectric polymer film precursor composition comprises a ferroelectric polymer and a casting solvent; and
removing at least a portion of the casting solvent composition to produce the ferroelectric polymer film.

11. The process of claims 9 or 10, wherein the adhesion promoter composition and the ferroelectric polymer film precursor composition are the same composition, and are disposed onto the substrate simultaneously.

12. The process of claims 9 or 10 wherein the ferroelectric polymer film has an atomic force microscopy roughness of less than 25 Angstroms, a polydispersity of less than 3, and a Curie transition temperature of greater than 90 degrees Celsius.
